(19) United States
(12) Patent Application Publication
(10) Pub. No.: US 2023/0276357 A1
(43) Pub. Date: Aug. 31, 2023

(54) APPARATUS, SYSTEM, AND METHOD OF UPDATING A TARGET WAKE TIME (TWT) AGREEMENT

(71) Applicant: Intel Corporation, Santa Clara, CA (US)

(72) Inventor: Laurent Cariou, Milizac (FR)

(73) Assignee: Intel Corporation, Santa Clara, CA (US)

(21) Appl. No.: 18/312,352

(22) Filed: May 4, 2023

(51) Int. Cl. H04W 52/02

(52) U.S. Cl. CPC H04W 52/0216

(57) ABSTRACT

For example, a first station (STA) may be configured to set up a Target Wake Time (TWT) agreement with a second STA, the TWT agreement to define a plurality of TWT Service Periods (SPs) for the first STA according to a first setting of one or more TWT SP parameters; and to select to transmit a frame to the second STA after setting up the TWT agreement, the frame including one or more TWT parameter fields configured to update a definition of one or more TWT SPs of the plurality of TWT SPs according to a second setting of the one or more TWT SP parameters, wherein the second setting of the one or more TWT SP parameters is different from the first setting of the one or more TWT SP parameters.

### TECHNICAL FIELD

Aspects described herein generally relate to updating a Target Wake Time (TWT) agreement.

### BACKGROUND

Devices in a wireless communication system may be configured to communicate according to communication protocols, which may utilize a Target Wake Time (TWT) for communication between a first device, e.g., an Access Point (AP), and a second device, e.g., a non-AP wireless communication station.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a Target Wake Time (TWT) information field format, which may be implemented in accordance with some demonstrative aspects.

FIG. 3 is a schematic illustration of a new TWT parameters field format, in accordance with some demonstrative aspects.

FIG. 4 is a schematic flow-chart illustration of a method of updating a TWT agreement, in accordance with some demonstrative aspects.

FIG. 5 is a schematic flow-chart illustration of a method of updating a TWT agreement, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11ax (IEEE 802.11ax-2021, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications; Amendment 1: Enhancements for High-Efficiency WLAN, February 2021) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

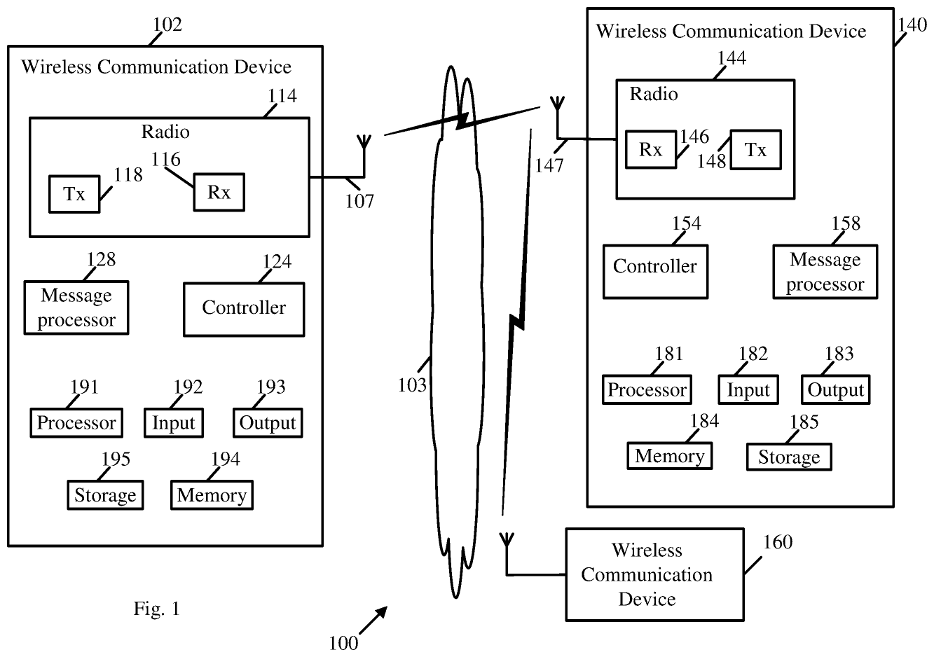

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include on or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a WiFi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a WiFi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11ax Specification, and/or any other specification and/or protocol.

In some demonstrative aspects, device 102 may include, operate as, perform a role of, and/or perform the functionality of, an AP STA.

In some demonstrative aspects, device 140, and/or device 160 may include, operate as, perform a role of, and/or perform the functionality of, one or more non-AP STAs. For example, device 140 may include, operate as, perform a role of, and/or perform the functionality of, at least one non-AP STA, and/or device 160 may include, operate as, perform a role of, and/or perform the functionality of, at least one non-AP STA.

In some demonstrative aspects, device 102, device 140, and/or device 160 may be configured to implement one or more operations of a Target Wake Time (TWT) mechanism, which may be configured to provide a technical solution to support setting up a TWT agreement between a requester STA, e.g., a STA implemented by device 140, and a responder STA, e.g., a STA implemented by device 102, e.g., as described below.

In some demonstrative aspects, the TWT agreement may include a Peer-to-Peer (P2P) TWT agreement, e.g., as described below.

In other aspects, the TWT agreement may include any other type of agreement.

In some demonstrative aspects, device 102, device 140, and/or device 160 may be configured to implement one or more operations of a TWT mechanism, which may be configured to support negotiating and/or imposing a TWT agreement, e.g., a P2P TWT agreement and/or any other TWT agreement, between a STA and its associated AP.

In some demonstrative aspects, the TWT agreement may define a plurality of TWT Service Periods (SPs) for the requester STA, e.g., as described below.

For example, the STA implemented by device 140 may negotiate and/or set up the TWT agreement with the STA implemented by device 102.

In some demonstrative aspects, the TWT agreement may include a P2P TWT agreement, which may define a plurality of P2P TWT SPs, e.g., as described below.

In other aspects, the TWT agreement may include any other type of TWT agreement to define any other additional or alternative type of TWT SPs.

In some demonstrative aspects, a P2P TWT SP may be requested and/or negotiated by STAs, e.g., according to one or more of the following operations:
a requester STA, e.g., a non-AP STA, may send to a responder STA, e.g., an AP STA, a Channel Usage Request frame, for example, to request and/or negotiate a P2P TWT SP according to a P2P TWT agreement. For example, the Channel Usage Request frame may include a Channel Usage element including a TWT element. For example, the TWT element may be configured to describe one or more timing parameters of the requested P2P TWT SP, e.g., an SP start time, an SP duration, an SP interval, and/or any other additional or alternative timing parameter defining the P2P TWT SP.
the responder STA, may respond with a Channel Usage Response frame. For example, the Channel Usage Response frame may include the same Channel Usage element, and the TWT element to carry a response on the P2P TWT agreement. For example, when the responder STA accepts the P2P TWT agreement, the Channel Usage Response frame may include “Accept” in a TWT Setup Command field.

In some demonstrative aspects, device 102, device 140, and/or device 160 may be configured to implement the one or more operations of a TWT mechanism, which may be configured to support setting up of a TWT agreement for a specific mode, for example, a P2P mode, e.g., as described below.

In some demonstrative aspects, for example, at the specific mode, the responder STA, e.g., the AP, may accept, e.g., shall accept, the P2P TWT agreement requested by the requester STA, for example, if the requester STA sent the Channel Usage Request frame with a TWT element describing the P2P TWT SP, and with a Channel Usage element including no Channel Entry fields and with the Usage Mode field set to 3, e.g., for “Peer-to-peer link indication”.

In some demonstrative aspects, a P2P TWT agreement may be utilized by a non-AP STA to set up one or more P2P TWT SPs with an AP. For example, the non-AP STA may utilize the P2P TWT SPs for P2P communication, e.g., with another with

For example, a STA implemented by device 140 may be associated with an AP implemented by device 102, and may also have an established P2P connection with a STA implemented by device 160. According to this example, the STA implemented by device 140 may set up a P2P TWT agreement with the AP implemented by device 102, for example, to define one or more the P2P TWT SPs, which may be utilized for P2P communication between the STA implemented by device 140 and the STA implemented by device 160.

For example, once a P2P TWT agreement is agreed and active, the responder STA, e.g., the AP, may consider, e.g., shall consider, the requester STA, e.g., the non-AP STA, to be in power save mode and doze state, e.g., at the start of the P2P TWT SP defined by the P2P TWT agreement.

For example, the responder STA, e.g., the AP, may consider, e.g., shall consider, the requester STA, e.g., the non-AP STA, to be back to its original power management mode and state, e.g., at the end of the P2P TWT SP, for example, unless the responder STA, e.g., the AP, receives a Quality of Service (QoS) Data frame, a QoS Null frame, and/or a Management frame from the requester STA within a time that overlaps with the P2P TWT SP.

In one example, the mechanism of the P2P TWT agreement may be utilized, for example, by a non-AP STA, which is associated with an infrastructure AP, and which also has a P2P connection with another peer non-AP STA.

In another example, the mechanism of the P2P TWT agreement may be utilized, for example, by a non-AP STA, which is associated with an infrastructure (infra) AP, and which also operates as a Soft AP or a Mobile AP.

For example, the mechanism of the P2P TWT agreement may be utilized by the non-AP STA, for example, to multiplex in time operation with the infra AP, and the peer non-AP STA, e.g., during P2P operation.

For example, the mechanism of the P2P TWT agreement may be utilized by the non-AP STA, for example, to indicate to the AP, e.g., the infrastructure AP, one or more SPs (P2P SPs), during which the non-AP STA will be unavailable for communication with the AP. For example, the one or more P2P SPs may be utilized by the non-AP STA for P2P operation with another peer STA.

For example, the AP may, e.g., will, not operate with the non-AP STA during the indicated P2P SP time and may consider the non-AP STA to be in a doze mode.

For example, depending on a P2P protocol the non-AP STA and its peer use, the non-AP STA may set up an agreement with its peer to schedule one or more timeslots to be used for the P2P operation.

In some demonstrative aspects, for example, in some use cases, scenarios, and/or implementations, there may be a need for the non-AP STA to make sure that the schedule of the P2P operation fits into the one or more scheduled P2P TWT SPs defined according to the P2P agreement with the AP.

In some demonstrative aspects, there may be a need to provide a technical solution for a situation where the P2P schedule of the P2P operation and the schedule of the P2P TWTs may be based on a different clock. For example, the P2P schedule of the P2P operation may be based on a first clock used by the non-AP STA and the P2P peer, while the schedule of the P2P TWTs may be based on a second clock used by the non-AP STA and AP.

In some demonstrative aspects, there may be drifts between a P2P SP, which is used by the non-AP STA and its peer, and a TWT SP, e.g., a P2P TWT SP, which is used by the non-AP STA and AP, e.g., the infra AP. As a result, the P2P SP and the TWT SP, which are supposed to be substantially overlapping, may become progressively non-overlapping.

In some demonstrative aspects, there may be a need the non-AP STA to re-adjust and/or shift in time a TWT SP, e.g., a P2P TWT SP, for example, so that the AP, e.g., the infra AP, may be made aware of a correct SP.

In some demonstrative aspects, device 102, device 140, and/or device 160 may be configured to implement one or more operations of a TWT update mechanism, which may be configured to support updating and/or modifying a TWT agreement, e.g., as described below.

In some demonstrative aspects, the TWT update mechanism may be configured to support updating and/or modifying one or more parameters of the TWT agreement, e.g., as described below.

In some demonstrative aspects, the TWT update mechanism may be configured to support updating and/or modifying one or more TWT SP parameters of the TWT agreement, e.g., as described below.

In some demonstrative aspects, the TWT update mechanism may be configured to support updating and/or modifying one or more timing parameters of the TWT agreement, e.g., as described below.

In some demonstrative aspects, device 102, device 140, and/or device 160 may be configured to implement one or more operations of a P2P TWT update mechanism, which may be configured to support updating and/or modifying a P2P TWT agreement, e.g., as described below.

In some demonstrative aspects, the P2P TWT update mechanism may be configured to provide a technical solution to support a requester STA, e.g., a STA implemented by device 140, to update and/or modify a P2P TWT agreement, e.g., that has been established with a mode where a responder STA, e.g., a STA implemented by device 102, shall accept the TWT agreement, e.g., as described below.

In some demonstrative aspects, the P2P TWT update mechanism may be configured to provide a technical solution to support the requester STA, e.g., the STA implemented by device 140, to update and/or modify the P2P TWT agreement, for example, without a need to repeat an exchange of Channel Usage Request and/or Response frames with the responder STA, e.g., as described below.

In some demonstrative aspects, device 102, device 140, and/or device 160 may be configured to implement the one or more operations of a TWT update mechanism, which may be configured to provide a technical solution to support synchronization between one or more P2P TWT SPs and one or more P2P timeslots, e.g., as described below.

In some demonstrative aspects, the TWT update mechanism may be configured to provide a technical solution to support synchronization between the P2P TWT SPs and the P2P timeslots, for example, even without a need to re-send Channel Usage Request and/or Response frames, e.g., as described below.

In some demonstrative aspects, controller 154 may be configured to control, trigger, cause, and/or instruct a first STA implemented by device 140, to set up a TWT agreement with a second STA, e.g., as described below.

For example, the STA implemented by device 140 may set up the TWT agreement with a STA implemented by device 102.

In some demonstrative aspects, the TWT agreement may be configured to define a plurality of TWT SPs for the first STA, for example, according to a first setting of one or more TWT SP parameters, e.g., as described below.

In some demonstrative aspects, controller 154 may be configured to control, trigger, cause, and/or instruct the first STA implemented by device 140 to select to transmit a frame to the second STA after setting up the TWT agreement, for example to update the TWT agreement, e.g., as described below.

In some demonstrative aspects, the frame may include one or more TWT parameter fields configured to update a definition of one or more TWT SPs of the plurality of TWT SPs, e.g., as described below.

In some demonstrative aspects, the one or more TWT parameter fields in the frame may be configured to update the definition of the one or more TWT SPs, for example, according to a second setting of the one or more TWT SP parameters, e.g., as described below.

In some demonstrative aspects, the second setting of the one or more TWT SP parameters may be different from the first setting of the one or more TWT SP parameters, e.g., as described below.

In some demonstrative aspects, the first STA, e.g., the STA implemented by device 140, may include a non-AP STA.

In some demonstrative aspects, the second STA, e.g., the STA implemented by device 102, may include an AP.

In other aspects, the first STA and the second STA may include any other type of STAs.

In some demonstrative aspects, controller 154 may be configured to control, trigger, cause, and/or instruct the first STA implemented by device 140 to transmit to the second STA a capability indication to indicate that the first STA supports a TWT parameter update mode, e.g., as described below.

In some demonstrative aspects, controller 154 may be configured to allow the first STA implemented by device 140 to transmit the frame to the second STA, for example, based on a determination that a capability indication from the second STA indicates that the second STA supports the TWT parameter update mode, e.g., as described below.

For example, controller 154 may be configured to prohibit the first STA implemented by device 140 to transmit the frame to the second STA, for example, based on a determination that the capability indication from the second STA does not indicate that the second STA supports the TWT parameter update mode, e.g., as described below.

For example, controller 154 may be configured to allow the first STA implemented by device 140 to transmit the frame to the second STA, for example, only if it is determined that the capability indication from the second STA indicates that the second STA supports the TWT parameter update mode, e.g., as described below.

In some demonstrative aspects, the plurality of TWT SPs defined by the TWT agreement may include a periodic sequence of TWT SPs, e.g., as described below.

In some demonstrative aspects, the TWT agreement may be configured to define the plurality of TWT SPs as TWT SPs during which the first STA is to be unavailable for communication with the second STA, e.g., as described below.

For example, based on the TWT agreement, the STA implemented by device 102 may consider the STA implemented by device 140 to be unavailable for communication with the STA implemented by device 102, for example, during the TWT SPs defined in the TWT agreement.

In some demonstrative aspects, the first STA implemented by device 140 may select to transmit the frame including the one or more TWT parameter fields configured to update a definition of an immediately next TWT SP, which is immediately after transmission of the frame, e.g., as described below.

In some demonstrative aspects, the frame may include a TWT flow Identifier (ID) field including a TWT flow ID of the TWT agreement, e.g., as described below.

In some demonstrative aspects, the frame may include a TWT information field, which may be configured to include the TWT flow ID field including the TWT flow ID of the TWT agreement, e.g., as described below.

In other aspects, the frame may include any other additional or alternative type of field to include the TWT flow ID of the TWT agreement.

In some demonstrative aspects, the TWT agreement may include a P2P TWT agreement, e.g., as described below.

In some demonstrative aspects, the plurality of TWT SPs may include a plurality of P2P TWT SPs, for example, based on communications between the first STA and a third STA, e.g., as described above.

For example, the plurality of P2P TWT SPs defined in the P2P TWT agreement may be based on communications between the first STA, e.g., the STA implemented by device 140, and a third STA, e.g., a STA implemented by device 160.

In some demonstrative aspects, controller 154 may be configured to control, trigger, cause, and/or instruct the first STA implemented by device 140 to determine the second setting of the one or more TWT SP parameters, for example, based on a schedule of the communications between the first STA and the third STA.

In other aspects, the TWT agreement may include any other type of agreement, and/or the TWT SPs may include any other type of TWT SPs.

In some demonstrative aspects, controller 154 may be configured to control, trigger, cause, and/or instruct the first STA implemented by device 140 to select to transmit the frame after one or more first TWT SPs of the plurality of TWT SPs, e.g., as described below.

In some demonstrative aspects, the one or more first TWT SPs may be defined, for example, according to the first setting of the one or more TWT SP parameters, e.g., as described below.

In some demonstrative aspects, the one or more TWT parameter fields in the frame may be configured to update a definition of one or more second TWT SPs of the plurality of TWT SPs, for example, according to the second setting of the one or more TWT SP parameters, e.g., as described below.

In some demonstrative aspects, the one or more TWT SP parameters may include one or more TWT SP timing parameters, e.g., as described below.

In some demonstrative aspects, the one or more TWT parameter fields may include a target-wake-time field to indicate a start time of a next TWT SP after transmission of the frame, e.g., as described below.

In some demonstrative aspects, the one or more TWT parameter fields may include at least one field configured to indicate a time interval between two consecutive TWT SPs, e.g., as described below.

In some demonstrative aspects, the one or more TWT parameter fields may include a TWT wake interval mantissa field and a wake interval exponent field, which may be configured to indicate a time interval between two consecutive TWT SPs, e.g., as described below.

In other aspects, the one or more TWT parameter fields may include any other additional or alternative timing parameters.

In some demonstrative aspects, the one or more TWT parameter fields may include a duration field configured to indicate a TWT SP duration, e.g., as described below.

In some demonstrative aspects, a TWT parameter field of the one or more TWT parameter fields may include a value of a TWT SP parameter, for example, according to the second setting of the one or more TWT SP parameters, e.g., as described below.

In some demonstrative aspects, a TWT parameter field of the one or more TWT parameter fields may include a difference value, for example, based on a difference between a first value and a second value, e.g., as described below.

In some demonstrative aspects, the first value may include a value of a TWT SP parameter according to the second setting of the one or more TWT SP parameters, e.g., as described below.

In some demonstrative aspects, the second value may include a value of the TWT SP parameter according to the first setting of the one or more TWT SP parameters, e.g., as described below.

In some demonstrative aspects, controller 154 may be configured to control, trigger, cause, and/or instruct the first STA implemented by device 140 to transmit the frame during a TWT SP of the plurality of TWT SPs, e.g., as described below.

In some demonstrative aspects, controller 154 may be configured to control, trigger, cause, and/or instruct the first STA implemented by device 140 to transmit the frame between two TWT SPs of the plurality of TWT SPs, e.g., as described below.

In some demonstrative aspects, controller 154 may be configured to control, trigger, cause, and/or instruct the first STA implemented by device 140 to transmit a first frame to the second STA to set up the TWT agreement, e.g., as described below.

In some demonstrative aspects, the first frame may be configured to include a first setting of the one or more TWT parameter fields, for example, to define the plurality of TWT SPs according to the first setting of the one or more TWT SP parameters, e.g., as described below.

In some demonstrative aspects, controller 154 may be configured to control, trigger, cause, and/or instruct the first STA implemented by device 140 to transmit a second frame to the second STA, e.g., as described below.

In some demonstrative aspects, the second frame may be configured to include a second setting of the one or more TWT parameter fields, for example, to update the definition of the one or more TWT SPs according to the second setting of the one or more TWT SP parameters, e.g., as described below.

In some demonstrative aspects, the frame transmitted from the first STA to the second STA to update the TWT agreement may include a TWT information frame, e.g., as described below.

In some demonstrative aspects, the TWT information frame may include a new-TWT-parameters field, e.g., as described below.

In some demonstrative aspects, the new-TWT-parameters field may include the one or more TWT parameter fields configured to update the definition of the one or more TWT SPs, for example, according to the second setting of the one or more TWT SP parameters, e.g., as described below.

In some demonstrative aspects, the TWT information frame may include a TWT information field including a next TWT subfield, e.g., as described below.

In some demonstrative aspects, the next TWT subfield may include the one or more TWT parameter fields configured to update the definition of the one or more TWT SPs, for example, according to the second setting of the one or more TWT SP parameters, e.g., as described below.

In other aspects, the TWT information frame may include any other additional or alternative type of subfields to indicate a setting of the one or more TWT SP parameters.

In some demonstrative aspects, controller 124 may be configured to control, trigger, cause, and/or instruct a first STA implemented by device 102 to set up a TWT agreement with a second STA, e.g., as described below.

In some demonstrative aspects, the TWT agreement may be configured to define a plurality of TWT SPs for the second STA, for example, according to a first setting of one or more TWT SP parameters, e.g., as described below.

In some demonstrative aspects, controller 124 may be configured to control, trigger, cause, and/or instruct the first STA implemented by device 102 to determine that the TWT agreement is to be updated, for example, based on a frame received from the second STA after setting up the TWT agreement, e.g., as described below.

In some demonstrative aspects, the received frame may include the frame transmitted by the second STA, e.g., the STA implemented by device 140.

In some demonstrative aspects, controller 124 may be configured to control, trigger, cause, and/or instruct the first STA implemented by device 102 to update a definition of one or more TWT SPs of the plurality of TWT SPs according to a second setting of the one or more TWT SP parameters, for example, based on one or more TWT parameter fields in the frame, e.g., as described below.

In some demonstrative aspects, the second setting of the one or more TWT SP parameters may be different from the first setting of the one or more TWT SP parameters, e.g., as described below.

In some demonstrative aspects, the first STA, e.g., the STA implemented by device 102, may include an AP.

In some demonstrative aspects, the second STA, e.g., the STA implemented by device 140, may include a non-AP STA.

In other aspects, the first STA and/or the second STA may include any other type of STAs.

In some demonstrative aspects, controller 124 may be configured to control, trigger, cause, and/or instruct the first STA implemented by device 102 to transmit to the second STA a capability indication to indicate that the first STA supports a TWT parameter update mode, e.g., as described below.

In some demonstrative aspects, controller 124 may be configured to control, trigger, cause, and/or instruct the first STA implemented by device 102 to identify that the second STA supports the TWT parameter update mode, for example, based on a capability indication from the second STA, e.g., as described below.

In some demonstrative aspects, the plurality of TWT SPs defined by the TWT agreement may include a periodic sequence of TWT SPs, e.g., as described below.

In some demonstrative aspects, the TWT agreement may be configured to define the plurality of TWT SPs as TWT SPs during which the second STA is to be unavailable for communication with the first STA, e.g., as described below.

For example, controller 124 may be configured to control, trigger, cause, and/or instruct the first STA implemented by device 102 to determine that the second STA to be unavailable for communication with the first STA during the TWT SPs defined by the TWT agreement with the second STA.

In some demonstrative aspects, controller 124 may be configured to control, trigger, cause, and/or instruct the first STA implemented by device 102 to update a definition of an immediately next TWT SP, which is immediately after reception of the frame, for example, based the one or more TWT parameter fields in the received frame, e.g., as described below.

In some demonstrative aspects, controller 124 may be configured to control, trigger, cause, and/or instruct the first STA implemented by device 102 to process the received frame to identify a TWT flow ID field including a TWT flow ID of the TWT agreement, e.g., as described below.

In some demonstrative aspects, controller 124 may be configured to control, trigger, cause, and/or instruct the first STA implemented by device 102 to process the received frame to identify the TWT flow ID field in a TWT information field, e.g., as described below.

In other aspects, the frame may include the TWT flow ID in any other type of field or subfield.

In some demonstrative aspects, the TWT agreement may include a P2P TWT agreement, e.g., as described above.

In some demonstrative aspects, the plurality of TWT SPs defined by the TWT agreement may include a plurality of P2P TWT SPs, for example, based on communications between the second STA and a third STA.

For example, the plurality of TWT SPs may include a plurality of P2P TWT SPs based on communications between the second STA, e.g., the STA implemented by device 140, and the third STA, e.g., the STA implemented by device 160.

In other aspects, the TWT agreement may include any other additional or alternative type of agreement, and/or the TWT SPs may include any other additional or alternative type of TWT SPs.

In some demonstrative aspects, controller 124 may be configured to control, trigger, cause, and/or instruct the first STA implemented by device 102 to determine that the TWT agreement is to be updated, for example, based on the frame, which may be received after one or more first TWT SPs of the plurality of TWT SPs, e.g., as described below.

In some demonstrative aspects, the one or more first TWT SPs may be defined, for example, according to the first setting of the one or more TWT SP parameters, e.g., as described below.

In some demonstrative aspects, controller 124 may be configured to control, trigger, cause, and/or instruct the first STA implemented by device 102 to update a definition of one or more second TWT SPs of the plurality of TWT SPs, for example, according to the second setting of the one or more TWT SP parameters, e.g., as described below.

In some demonstrative aspects, controller 124 may be configured to control, trigger, cause, and/or instruct the first STA implemented by device 102 to determine one or more TWT SP timing parameters of the one or more TWT SPs, for example, based on the one or more TWT SP parameter fields in the frame, e.g., as described below.

In some demonstrative aspects, controller 124 may be configured to control, trigger, cause, and/or instruct the first STA implemented by device 102 to determine a start time of a next TWT SP after the frame, for example, based on a target-wake-time field in the frame, e.g., as described below.

In some demonstrative aspects, controller 124 may be configured to control, trigger, cause, and/or instruct the first STA implemented by device 102 to determine a time interval between two consecutive TWT SPs, for example, based on the one or more TWT parameter fields in the frame, e.g., as described below.

In some demonstrative aspects, controller 124 may be configured to control, trigger, cause, and/or instruct the first STA implemented by device 102 to determine a time interval between two consecutive TWT SPs, for example, based on a TWT wake interval mantissa field and a wake interval exponent field in the frame, e.g., as described below.

In other aspects, controller 124 may be configured to control, trigger, cause, and/or instruct the first STA implemented by device 102 to determine the time interval between two consecutive TWT SPs based on any other additional or alternative parameters and/or fields in the frame.

In some demonstrative aspects, controller 124 may be configured to control, trigger, cause, and/or instruct the first STA implemented by device 102 to determine a TWT SP duration of the one or more TWT SPs, for example, based on a duration field in the frame, e.g., as described below.

In some demonstrative aspects, controller 124 may be configured to control, trigger, cause, and/or instruct the first STA implemented by device 102 to identify that a TWT parameter field of the one or more TWT parameter fields includes a value of a TWT SP parameter according to the second setting of the one or more TWT SP parameters, e.g., as described below.

In some demonstrative aspects, controller 124 may be configured to control, trigger, cause, and/or instruct the first STA implemented by device 102 to identify that a TWT parameter field of the one or more TWT parameter fields includes a difference value, for example, based on a difference between a first value and a second value, e.g., as described below.

In some demonstrative aspects, the first value may include a value of a TWT SP parameter according to the second setting of the one or more TWT SP parameters, and the second value may include a value of the TWT SP parameter according to the first setting of the one or more TWT SP parameters, e.g., as described below.

In some demonstrative aspects, the first STA implemented by device 102 may receive the frame from the second STA during a TWT SP of the plurality of TWT SPs, e.g., as described below.

In other aspects, the first STA implemented by device 102 may receive the frame from the second STA between two TWT SPs of the plurality of TWT SPs.

In some demonstrative aspects, controller 124 may be configured to control, trigger, cause, and/or instruct the first STA implemented by device 102 to set up the TWT agreement with the second STA, for example, based on a first frame from the second STA, e.g., as described below.

In some demonstrative aspects, the first frame may include a first setting of the one or more TWT parameter fields to define the plurality of TWT SPs according to the first setting of the one or more TWT SP parameters, e.g., as described below.

In some demonstrative aspects, controller 124 may be configured to control, trigger, cause, and/or instruct the first STA implemented by device 102 to determine that the TWT agreement is to be updated, for example, based on a second frame from the second STA, e.g., as described below.

In some demonstrative aspects, the second frame may include a second setting of the one or more TWT parameter fields to update the definition of the one or more TWT SPs according to the second setting of the one or more TWT SP parameters, e.g., as described below.

In some demonstrative aspects, the frame received from the second STA to update the TWT agreement may include a TWT information frame, e.g., as described below.

In some demonstrative aspects, controller 124 may be configured to control, trigger, cause, and/or instruct the first STA implemented by device 102 to process a new-TWT-parameters field in the TWT information frame to identify the one or more TWT parameter fields configured to update the definition of the one or more TWT SPs according to the second setting of the one or more TWT SP parameters, e.g., as described below.

In some demonstrative aspects, controller 124 may be configured to control, trigger, cause, and/or instruct the first STA implemented by device 102 to identify a TWT information field in the TWT information frame, e.g., as described below.

In some demonstrative aspects, controller 124 may be configured to control, trigger, cause, and/or instruct the first STA implemented by device 102 to process a next TWT subfield in the TWT information field to identify the one or more TWT parameter fields configured to update the definition of the one or more TWT SPs according to the second setting of the one or more TWT SP parameters, e.g., as described below.

In some demonstrative aspects, device 102, device 140, and/or device 160 may be configured to implement one or more operations of a TWT mechanism, which may be configured to support updating one or more parameters of a TWT agreement, e.g., as described below.

In some demonstrative aspects, the TWT mechanism may be configured to support updating one or more parameters defining one or more TWT SPs of the TWT agreement, e.g., as described below.

In some demonstrative aspects, the TWT mechanism may be configured to support updating one or more timing parameters defining the one or more TWT SPs of the TWT agreement, e.g., as described below.

In some demonstrative aspects, the TWT mechanism may be configured to support updating one or more parameters defining P2P TWT SPs of a P2P TWT agreement, e.g., as described below.

In other aspects, the TWT mechanism may be configured to support updating one or more parameters defining any other type of TWT SPs of any other type of TWT agreement.

In some demonstrative aspects, device 102 and/or device 140 may be configured to reuse a TWT Information Frame concept for signaling updated parameters for a TWT agreement, e.g., a P2P TWT agreement, between device 102 and device 140, e.g., as described below.

In some demonstrative aspects, the TWT Information Frame concept may be reused, for example, based on a TWT Flow ID, e.g., a specific TWT Flow ID, which may be assigned to the P2P TWT agreement.

In some demonstrative aspects, device 102 and/or device 140 may be allowed to use a TWT information frame to modify and/or shift one or more timing parameters corresponding to one or more TWT SPs, e.g., P2P TWT SPs, e.g., as described below.

In some demonstrative aspects, device 102 and/or device 140 may be configured to communicate a TWT information frame, which may be configured to include TWT update information to modify and/or shift a TWT start time, e.g., a Target Wake Time of a next TWT SP, to any suitable value and/or granularity.

For example, the TWT information frame may be reused to carry the TWT update information, for example, according to a TWT parameter update mode.

In one example, the TWT parameter update mode may be defined in addition to or instead of one or more other modes of the TWT information frame, for example, a mode for suspending a TWT agreement and/or resuming a TWT agreement, e.g., without changing a TWT start time.

In some demonstrative aspects, the TWT information frame may include a TWT Information field, which may be configured to include a subfield (also referred to as “next TWT subfield”), which may be configured to carry TWT update information to update the TWT agreement, e.g., as described below.

In some demonstrative aspects, the next TWT subfield may include a value of a start time of an immediately next TWT SP, e.g., in a “target wake time” subfield.

For example, the value of the start time of the immediately next TWT SP may be set to a slightly shifted value, e.g., compared to a start time initially expected for a next TWT SP, for example, based on one or more TWT parameters initially negotiated in the TWT agreement.

In other aspects, the value of the start time of the immediately next TWT SP may be included in any other additional or alterative field.

In some demonstrative aspects, one or more updated parameters of the TWT SP may be defined in a new field, which may be included, for example, directly in the TWT information frame, e.g., separate from the TWT information field.

In some demonstrative aspects, the TWT information frame may be configured to include a new field, e.g., a “New TWT Parameters” field, which may include one or more TWT parameter fields configured to update a definition of one or more TWT SPs, e.g., as described below.

For example, the New TWT Parameters field may follow the TWT Information field in the TWT information frame, e.g., as described below.

In some demonstrative aspects, the New TWT Parameters field may be configured to include a Target Wake Time field, and/or any other additional or alternative parameters for an updated and/or shifted TWT agreement, e.g., as described below.

In some demonstrative aspects, a responder STA, for example, an AP, e.g., a STA implemented by device 102, may be configured to update the TWT agreement, for example, based on information in the TWT information frame from the requester STA.

In some demonstrative aspects, the responder STA may update the TWT agreement, for example, in order to account for the TWT start time shift reported by the requester STA.

In one example, the responder STA may apply the TWT start time shift to immediately following TWT SPs. In another example, the responder STA may apply the TWT start time shift to all next TWT SPs.

In some demonstrative aspects, a requester STA, e.g., a STA implemented by device 140, may modify a time interval between two consecutive TWT SPs, for example, by including a TWT Wake Interval Mantissa field and/or a TWT Wake Interval Exponent field in the TWT Information frame transmitted to the responder STA.

In some demonstrative aspects, the TWT Wake Interval Mantissa field and/or the TWT Wake Interval Exponent field may be included in the New TWT Parameters field, e.g., as described below.

In other aspects, the TWT Wake Interval Mantissa field and/or the TWT Wake Interval Exponent field may be included in any other field of the TWT information frame.

In some demonstrative aspects, the responder STA, for example, an AP, e.g., a STA implemented by device 102, may update a TWT Wake Interval, e.g., the time interval between two consecutive TWT SPs, of the TWT agreement identified by the TWT Flow ID, e.g., in the TWT information frame. For example, the responder STA may apply the updated TWT Wake Interval toto one or more, e.g., some or all, intervals between consecutive TWT SPs for the TWT agreement.

In some demonstrative aspects, device 102, device 140, and/or device 160 may be configured to implement the TWT update mechanism to update one or more duration parameters defining a duration of the one or more TWT SPs of the TWT agreement, e.g., as described below.

For example, the one or more duration parameters may include a Nominal Minimum Wake Duration, e.g., representing an SP duration.

In some demonstrative aspects, device 102, device 140, and/or device 160 may be configured to implement the TWT update mechanism to update one or more additional or alternative parameters of the TWT agreement.

In some demonstrative aspects, the TWT parameter fields may be configured to encode the updated TWT parameters according to one or more encoding schemes, e.g., as described below.

In one example, the requester STA may transmit to the responder STA the updated TWT parameters by including the actual value of the updated parameters, for example, as new timing values. For example, device 140 may configure the TWT information frame to include an updated target wake time in the TWT field, and/or an updated TWT Wake Interval Mantissa Shift in the TWT Wake Interval Mantissa Shift field.

In one example, the requester STA may transmit to the responder STA the updated TWT parameters in the form of differential values, e.g., including a difference value representing a time shift between a new timing value and a current timing value. For example, device 140 may configure the TWT information frame to include a difference between an updated target wake time and a current target wake time in the TWT field, and/or a difference between an updated TWT Wake Interval Mantissa Shift and a current TWT Wake Interval Mantissa Shift in the TWT Wake Interval Mantissa Shift field.

In some demonstrative aspects, device 102 and/or device 140 may communicate a capability indication configured to indicate that both device 102 and device 140 support a TWT parameter update mode.

In some demonstrative aspects, device 102 and/or device 140 may be configured to generate, transmit, receive and/or process a TWT information frame including a new TWT parameters field, which may include one or more TWT parameter fields configured to update one or more TWT parameters, e.g., as described above.

In some demonstrative aspects, the TWT information frame may be defined, for example, to include some or all of the fields of the following format:

TABLE 1

| Order | Information |
|---|---|
| 1 | Category |
| 2 | Unprotected S1G Action |
| 3 | TWT Information |
| 4 | New TWT Parameters |

In some demonstrative aspects, the New TWT Parameters field may be after the TWT Information field.

In some demonstrative aspects, the New TWT Parameters field may include one or more subfields to update the definition of one or more TWT SPs, e.g., as described below.

In some demonstrative aspects, the New TWT Parameters field may be configured to update the definition of one or more TWT SPs of a TWT agreement having a TWT ID indicated by the TWT Information field, e.g., as described below.

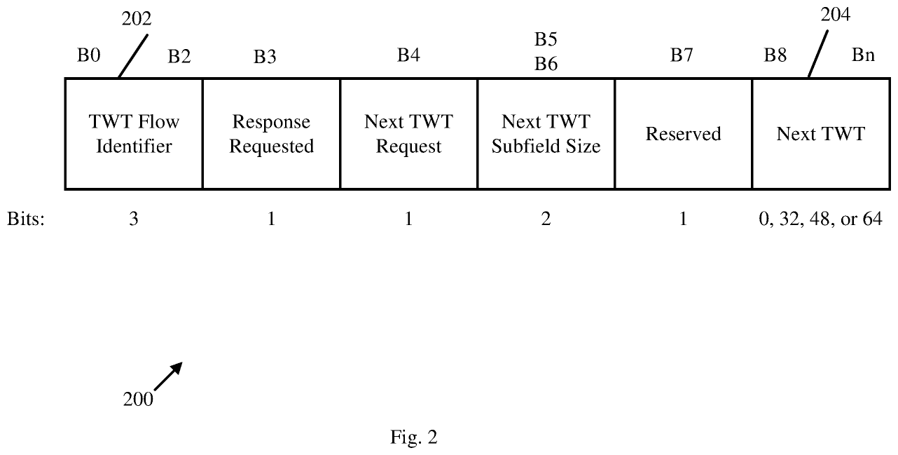

Reference is made to FIG. 2, which schematically illustrates a TWT information field 200, which may be implemented in accordance with some demonstrative aspects.

For example, device 102 (FIG. 1) and/or device 140 (FIG. 1) may be configured to generate, transmit, receive and/or process communicate a frame, e.g., a TWT information frame defined according to Table 1, including TWT information field 200.

In some demonstrative aspects, as shown in FIG. 2, TWT information field 200 may include a TWT flow ID subfield 202. For example, the TWT flow ID subfield 202 may include a TWT flow ID of a TWT agreement set up between device 102 (FIG. 1) and device 140 (FIG. 1).

In some demonstrative aspects, as shown in FIG. 2, TWT information field 200 may include a next TWT subfield 204, which may be set to include one or more TWT parameter fields configured to update the definition of one or more TWT SPs, e.g., as described above.

In some demonstrative aspects, the TWT information frame may include a field, which may be separate from the TWT information field 200, and may be configured to carry one or more TWT parameter fields configured to update the definition of one or more TWT SPs, e.g., as described below.

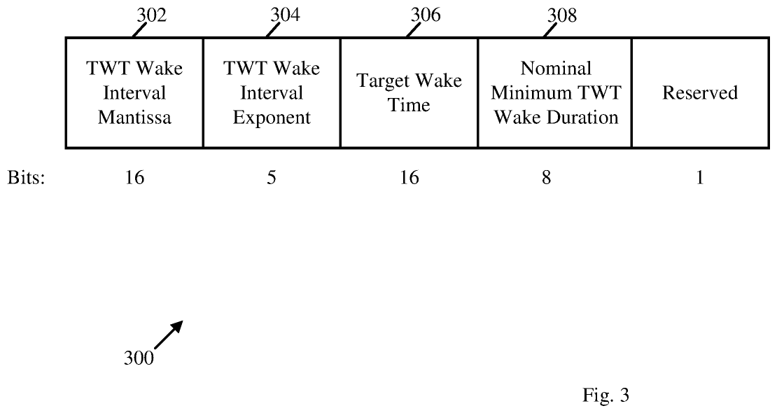

Reference is made to FIG. 3, which schematically illustrates a new-TWT-parameters field 300, in accordance with some demonstrative aspects.

In some demonstrative aspects, new-TWT-parameters field 300 may be included in a TWT information frame.

In some demonstrative aspects, new-TWT-parameters field 300 may be after a TWT information field, e.g., TWT information field 200 (FIG. 2), in a TWT information frame, e.g., according to the TWT information frame format of Table 1.

For example, device 102 (FIG. 1) and/or device 140 (FIG. 1) may be configured to generate, transmit, receive and/or process communicate a frame, e.g., a TWT information frame defined according to Table 1, including new-TWT-parameters field 300.

In other aspects, one or more fields of new-TWT-parameters field 300 may be included in any other field of a TWT information frame. In one example, one or more fields of new-TWT-parameters field 300 may be included as part of TWT information field 200 (FIG. 2), e.g., as part of next TWT field 204, and/or any other field of TWT information field 200 (FIG. 2).

other aspects, one or more fields of new-TWT-parameters field 300 may be included in any other additional or alternative type of frame.

In some demonstrative aspects, as shown in FIG. 3, new-TWT-parameters field 300 one or more TWT parameter fields configured to update a definition of one or more TWT SPs of a plurality of TWT SPs defined by a TWT agreement, e.g., a TWT agreement set up between device 102 (FIG. 1) and device 140 (FIG. 1).

In some demonstrative aspects, New TWT Parameters field 300 may be configured to update the definition of one or more TWT SPs of a TWT agreement having a TWT ID indicated by a TWT Information field, e.g., TWT flow ID 202 (FIG. 2) in TWT Information field 200 (FIG. 2), in the TWT information frame.

In some demonstrative aspects, as shown in FIG. 3, new-TWT-parameters field 300 may include a TWT wake interval mantissa field 302 and a wake interval exponent field 304, which may be configured to indicate a time interval between two consecutive TWT SPs.

In some demonstrative aspects, as shown in FIG. 3, new-TWT-parameters field 300 may include a target-wake-time field 306, which may be configured to indicate a start time of a next TWT SP after transmission of the frame.

In some demonstrative aspects, as shown in FIG. 3, new-TWT-parameters field 300 may include a nominal minimum TWT wake duration field 308, which may be configured to indicate a TWT SP duration.

In other aspects, new-TWT-parameters field 300 may include one or more additional or alternative fields, which may be configured to indicate any other suitable updated TWT parameters.

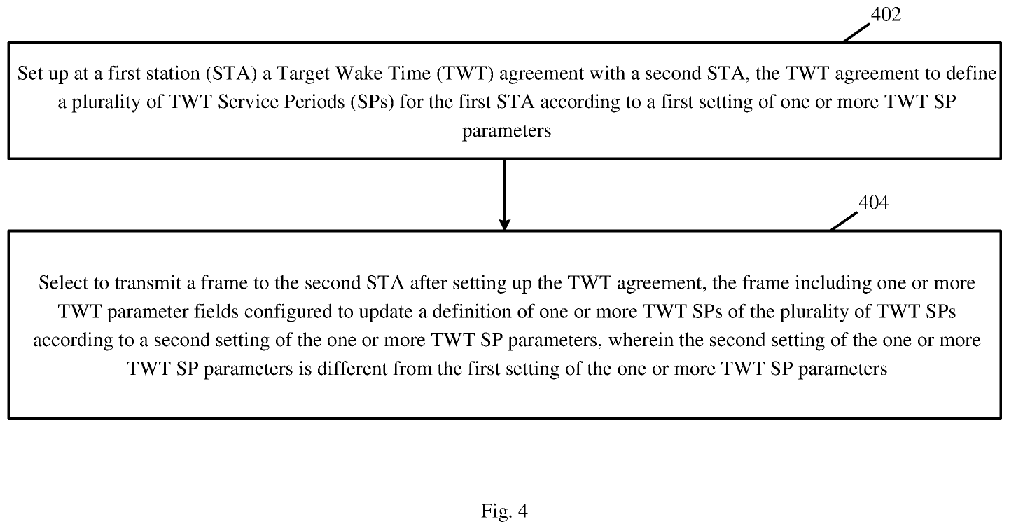

Reference is made to FIG. 4, which schematically illustrates a method of updating a TWT agreement, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include setting up at a first STA a TWT agreement with a second STA. For example, the TWT agreement may be configured to define a plurality of TWT SPs for the first STA according to a first setting of one or more TWT SP parameters. For example, controller 154 (FIG. 1) may be configured to cause, trigger, and/or control device 140 (FIG. 1) to set up a TWT agreement with device 102 (FIG. 1), for example, to define a plurality of TWT SPs for device 140 (FIG. 1) according to a first setting of one or more TWT SP parameters, e.g., as described above.

As indicated at block 404, the method may include selecting to transmit a frame to the second STA after setting up the TWT agreement. For example, the frame may include one or more TWT parameter fields configured to update a definition of one or more TWT SPs of the plurality of TWT SPs according to a second setting of the one or more TWT SP parameters. For example, the second setting of the one or more TWT SP parameters may be different from the first setting of the one or more TWT SP parameters. For example, controller 154 (FIG. 1) may be configured to cause, trigger, and/or control device 140 (FIG. 1) to select to transmit the frame to device 102 (FIG. 1) after setting up the TWT agreement, e.g., as described above.

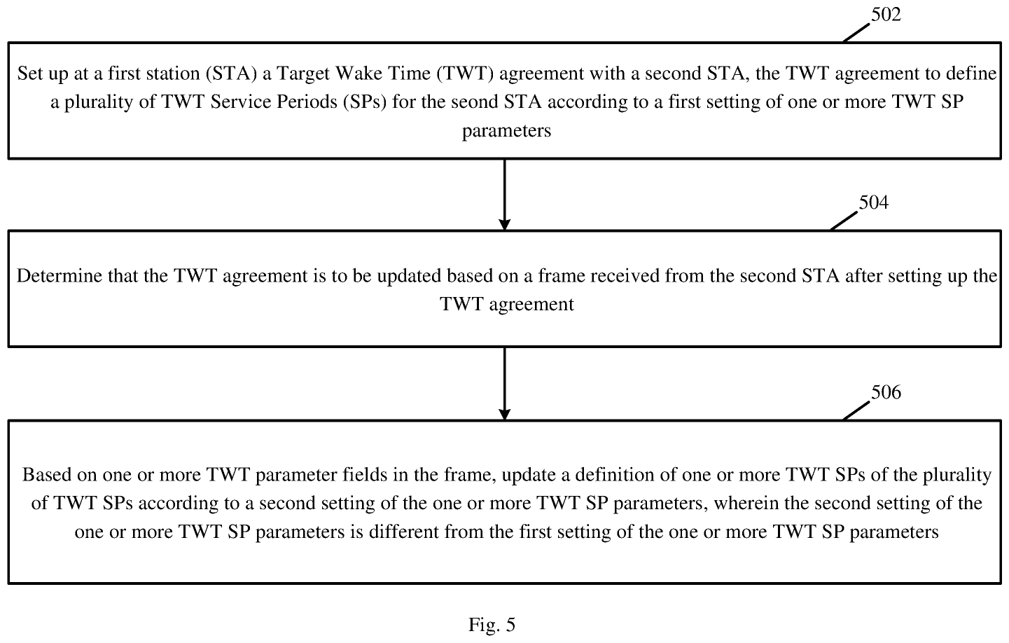

Reference is made to FIG. 5, which schematically illustrates a method of updating a TWT agreement, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include setting up at a first STA a TWT agreement with a second STA. For example, the TWT agreement may be configured to define a plurality of TWT SPs for the second STA according to a first setting of one or more TWT SP parameters. For example, controller 124 (FIG. 1) may be configured to cause, trigger, and/or control device 102 (FIG. 1) to set up a TWT agreement with device 140 (FIG. 1), for example, to define a plurality of TWT SPs for device 140 (FIG. 1) according to a first setting of one or more TWT SP parameters, e.g., as described above.

As indicated at block 504, the method may include determining that the TWT agreement is to be updated based on a frame received from the second STA after setting up the TWT agreement. For example, controller 124 (FIG. 1) may be configured to cause, trigger, and/or control device 102 (FIG. 1) to determine that the TWT agreement is to be updated based on a frame received from device 140 (FIG. 1) after setting up the TWT agreement, e.g., as described above.

As indicated at block 506, the method may include updating a definition of one or more TWT SPs of the plurality of TWT SPs according to a second setting of the one or more TWT SP parameters, for example, based on one or more TWT parameter fields in the frame. For example, the second setting of the one or more TWT SP parameters may be different from the first setting of the one or more TWT SP parameters. For example, controller 124 (FIG. 1) may be configured to cause, trigger, and/or control device 102 (FIG. 1) to update a definition of one or more TWT SPs of the plurality of TWT SPs according to a second setting of the one or more TWT SP parameters, for example, based on one or more TWT parameter fields in the frame from device 140 (FIG. 1), e.g., as described above.

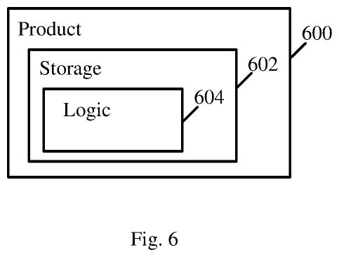

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, and 5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a first station (STA) to set up a Target Wake Time (TWT) agreement with a second STA, the TWT agreement to define a plurality of TWT Service Periods (SPs) for the first STA according to a first setting of one or more TWT SP parameters; and select to transmit a frame to the second STA after setting up the TWT agreement, the frame comprising one or more TWT parameter fields configured to update a definition of one or more TWT SPs of the plurality of TWT SPs according to a second setting of the one or more TWT SP parameters, wherein the second setting of the one or more TWT SP parameters is different from the first setting of the one or more TWT SP parameters.

Example 2 includes the subject matter of Example 1, and optionally, wherein the apparatus is configured to cause the first STA to select to transmit the frame after one or more first TWT SPs of the plurality of TWT SPs, the one or more first TWT SPs defined according to the first setting of the one or more TWT SP parameters, wherein the one or more TWT parameter fields in the frame are configured to update a definition of one or more second TWT SPs of the plurality of TWT SPs according to the second setting of the one or more TWT SP parameters.

Example 3 includes the subject matter of Example 1 or 2, and optionally, wherein the one or more TWT SP parameters comprise one or more TWT SP timing parameters.

Example 4 includes the subject matter of any one of Examples 1-3, and optionally, wherein the one or more TWT parameter fields comprise a target-wake-time field to indicate a start time of a next TWT SP after transmission of the frame.

Example 5 includes the subject matter of any one of Examples 1-4, and optionally, wherein the one or more TWT parameter fields comprise at least one field configured to indicate a time interval between two consecutive TWT SPs.

Example 6 includes the subject matter of any one of Examples 1-5, and optionally, wherein the one or more TWT parameter fields comprise a TWT wake interval mantissa field and a wake interval exponent field, which are configured to indicate a time interval between two consecutive TWT SPs.

Example 7 includes the subject matter of any one of Examples 1-6, and optionally, wherein the one or more TWT parameter fields comprise a duration field configured to indicate a TWT SP duration.

Example 8 includes the subject matter of any one of Examples 1-7, and optionally, wherein a TWT parameter field of the one or more TWT parameter fields comprises a value of a TWT SP parameter according to the second setting of the one or more TWT SP parameters.

Example 9 includes the subject matter of any one of Examples 1-8, and optionally, wherein a TWT parameter field of the one or more TWT parameter fields comprises a difference value based on a difference between a first value and a second value, wherein the first value comprises a value of a TWT SP parameter according to the second setting of the one or more TWT SP parameters, wherein the second value comprises a value of the TWT SP parameter according to the first setting of the one or more TWT SP parameters.

Example 10 includes the subject matter of any one of Examples 1-9, and optionally, wherein the apparatus is configured to cause the first STA to transmit the frame during a TWT SP of the plurality of TWT SPs.

Example 11 includes the subject matter of any one of Examples 1-10, and optionally, wherein the apparatus is configured to cause the first STA to transmit the frame between two TWT SPs of the plurality of TWT SPs.

Example 12 includes the subject matter of any one of Examples 1-11, and optionally, wherein the apparatus is configured to cause the first STA to transmit a first frame to the second STA to set up the TWT agreement, the first frame comprising a first setting of the one or more TWT parameter fields to define the plurality of TWT SPs according to the first setting of the one or more TWT SP parameters; and transmit a second frame to the second STA, the second frame comprising a second setting of the one or more TWT parameter fields to update the definition of the one or more TWT SPs according to the second setting of the one or more TWT SP parameters.

Example 13 includes the subject matter of any one of Examples 1-12, and optionally, wherein the frame comprises a TWT information frame.

Example 14 includes the subject matter of Example 13, and optionally, wherein the TWT information frame comprises a new-TWT-parameters field comprising the one or more TWT parameter fields configured to update the definition of the one or more TWT SPs according to the second setting of the one or more TWT SP parameters.

Example 15 includes the subject matter of Example 13, and optionally, wherein the TWT information frame comprises a TWT information field comprising a next TWT subfield, wherein the next TWT subfield comprises the one or more TWT parameter fields configured to update the definition of the one or more TWT SPs according to the second setting of the one or more TWT SP parameters.

Example 16 includes the subject matter of any one of Examples 13-15, and optionally, wherein the TWT information frame comprises a TWT information field, wherein the TWT information field comprises a TWT flow Identifier (ID) field comprising a TWT flow ID of the TWT agreement.

Example 17 includes the subject matter of any one of Examples 1-16, and optionally, wherein the frame comprises a TWT flow Identifier (ID) field comprising a TWT flow ID of the TWT agreement.

Example 18 includes the subject matter of any one of Examples 1-17, and optionally, wherein the TWT agreement comprises a Peer-to-Peer (P2P) TWT agreement, wherein the plurality of TWT SPs comprises a plurality of P2P TWT SPs based on communications between the first STA and a third STA.

Example 19 includes the subject matter of Example 18, and optionally, wherein the apparatus is configured to cause the first STA to determine the second setting of the one or more TWT SP parameters based on a schedule of the communications between the first STA and the third STA.

Example 20 includes the subject matter of any one of Examples 1-19, and optionally, wherein the one or more TWT parameter fields are configured to update a definition of an immediately next TWT SP, which is immediately after transmission of the frame.

Example 21 includes the subject matter of any one of Examples 1-20, and optionally, wherein the TWT agreement is configured to define the plurality of TWT SPs as TWT SPs during which the first STA is to be unavailable for communication with the second STA.

Example 22 includes the subject matter of any one of Examples 1-21, and optionally, wherein the apparatus is configured to cause the first STA to transmit to the second STA a capability indication to indicate that the first STA supports a TWT parameter update mode.

Example 23 includes the subject matter of any one of Examples 1-22, and optionally, wherein the apparatus is configured to allow the first STA to transmit the frame to the second STA based on a determination that a capability indication from the second STA indicates that the second STA supports a TWT parameter update mode.

Example 24 includes the subject matter of any one of Examples 1-23, and optionally, wherein the plurality of TWT SPs comprises a periodic sequence of TWT SPs.

Example 25 includes the subject matter of any one of Examples 1-24, and optionally, wherein the first STA comprises a non Access Point (AP) STA, and the second STA comprises an AP.

Example 26 includes the subject matter of any one of Examples 1-25, and optionally, comprising at least one radio to transmit the frame.

Example 27 includes the subject matter of Example 26, and optionally, comprising one or more antennas connected to the radio, and a processor to execute instructions of an operating system.

Example 28 includes an apparatus comprising logic and circuitry configured to cause a first station (STA) to set up a Target Wake Time (TWT) agreement with a second STA, the TWT agreement to define a plurality of TWT Service Periods (SPs) for the second STA according to a first setting of one or more TWT SP parameters; and determine that the TWT agreement is to be updated based on a frame received from the second STA after setting up the TWT agreement; and based on one or more TWT parameter fields in the frame, update a definition of one or more TWT SPs of the plurality of TWT SPs according to a second setting of the one or more TWT SP parameters, wherein the second setting of the one or more TWT SP parameters is different from the first setting of the one or more TWT SP parameters.

Example 29 includes the subject matter of Example 28, and optionally, wherein the apparatus is configured to cause the first STA to determine that the TWT agreement is to be updated based on the frame received after one or more first TWT SPs of the plurality of TWT SPs, the one or more first TWT SPs defined according to the first setting of the one or more TWT SP parameters, and to update a definition of one or more second TWT SPs of the plurality of TWT SPs according to the second setting of the one or more TWT SP parameters.

Example 30 includes the subject matter of Example 28 or 29, and optionally, wherein the apparatus is configured to cause the first STA to determine one or more TWT SP timing parameters of the one or more TWT SPs based on the one or more TWT SP parameter fields in the frame.

Example 31 includes the subject matter of any one of Examples 28-30, and optionally, wherein the apparatus is configured to cause the first STA to determine a start time of a next TWT SP after the frame based on a target-wake-time field in the frame.

Example 32 includes the subject matter of any one of Examples 28-31, and optionally, wherein the apparatus is configured to cause the first STA to determine a time interval between two consecutive TWT SPs based on the one or more TWT parameter fields.

Example 33 includes the subject matter of any one of Examples 28-32, and optionally, wherein the apparatus is configured to cause the first STA to determine a time interval between two consecutive TWT SPs based on a TWT wake interval mantissa field and a wake interval exponent field in the frame.

Example 34 includes the subject matter of any one of Examples 28-33, and optionally, wherein the apparatus is configured to cause the first STA to determine a TWT SP duration of the one or more TWT SPs based on a duration field in the frame.

Example 35 includes the subject matter of any one of Examples 28-34, and optionally, wherein the apparatus is configured to cause the first STA to identify that a TWT parameter field of the one or more TWT parameter fields comprises a value of a TWT SP parameter according to the second setting of the one or more TWT SP parameters.

Example 36 includes the subject matter of any one of Examples 28-35, and optionally, wherein the apparatus is configured to cause the first STA to identify that a TWT parameter field of the one or more TWT parameter fields comprises a difference value based on a difference between a first value and a second value, wherein the first value comprises a value of a TWT SP parameter according to the second setting of the one or more TWT SP parameters, wherein the second value comprises a value of the TWT SP parameter according to the first setting of the one or more TWT SP parameters.

Example 37 includes the subject matter of any one of Examples 28-36, and optionally, wherein the frame is received during a TWT SP of the plurality of TWT SPs.

Example 38 includes the subject matter of any one of Examples 28-36, and optionally, wherein the frame is received during between two TWT SPs of the plurality of TWT SPs.

Example 39 includes the subject matter of any one of Examples 28-38, and optionally, wherein the apparatus is configured to cause the first STA to set up the TWT agreement based on a first frame from the second STA, the first frame comprising a first setting of the one or more TWT parameter fields to define the plurality of TWT SPs according to the first setting of the one or more TWT SP parameters; and determine that the TWT agreement is to be updated based on a second frame from the second STA, the second frame comprising a second setting of the one or more TWT parameter fields to update the definition of the one or more TWT SPs according to the second setting of the one or more TWT SP parameters.

Example 40 includes the subject matter of any one of Examples 28-39, and optionally, wherein the frame comprises a TWT information frame.

Example 41 includes the subject matter of Example 40, and optionally, wherein the apparatus is configured to cause the first STA to process a new-TWT-parameters field in the TWT information frame to identify the one or more TWT parameter fields configured to update the definition of the one or more TWT SPs according to the second setting of the one or more TWT SP parameters.

Example 42 includes the subject matter of Example 40, and optionally, wherein the apparatus is configured to cause the first STA to identify a TWT information field in the TWT information frame, and to process a next TWT subfield in the TWT information field to identify the one or more TWT parameter fields configured to update the definition of the one or more TWT SPs according to the second setting of the one or more TWT SP parameters.

Example 43 includes the subject matter of any one of Examples 40-42, and optionally, wherein the TWT information frame comprises a TWT information field, wherein the TWT information field comprises a TWT flow Identifier (ID) field comprising a TWT flow ID of the TWT agreement.

Example 44 includes the subject matter of any one of Examples 28-43, and optionally, wherein the frame comprises a TWT flow Identifier (ID) field comprising a TWT flow ID of the TWT agreement.

Example 45 includes the subject matter of any one of Examples 28-44, and optionally, wherein the TWT agreement comprises a Peer-to-Peer (P2P) TWT agreement, wherein the plurality of TWT SPs comprises a plurality of P2P TWT SPs based on communications between the second STA and a third STA.

Example 46 includes the subject matter of any one of Examples 28-45, and optionally, wherein the apparatus is configured to cause the first STA to update a definition of an immediately next TWT SP, which is immediately after reception of the frame, based the one or more TWT parameter fields.

Example 47 includes the subject matter of any one of Examples 28-46, and optionally, wherein the TWT agreement is configured to define the plurality of TWT SPs as TWT SPs during which the second STA is to be unavailable for communication with the first STA.

Example 48 includes the subject matter of any one of Examples 28-47, and optionally, wherein the apparatus is configured to cause the first STA to transmit to the second STA a capability indication to indicate that the first STA supports a TWT parameter update mode.

Example 49 includes the subject matter of any one of Examples 28-48, and optionally, wherein the apparatus is configured to cause the first STA to identify that the second STA supports a TWT parameter update mode based on a capability indication from the second STA.

Example 50 includes the subject matter of any one of Examples 28-49, and optionally, wherein the plurality of TWT SPs comprises a periodic sequence of TWT SPs.

Example 51 includes the subject matter of any one of Examples 28-50, and optionally, wherein the first STA comprises an Access Point (AP), and the second STA comprises a non-AP STA.

Example 52 includes the subject matter of any one of Examples 28-51, and optionally, comprising at least one radio to receive the frame.

Example 53 includes the subject matter of Example 52, and optionally, comprising one or more antennas connected to the radio, and a processor to execute instructions of an operating system.

Example 54 comprises a wireless communication device comprising the apparatus of any of Examples 1-53.

Example 55 comprises an apparatus comprising means for executing any of the described operations of any of Examples 1-53.

Example 56 comprises a product comprising one or more tangible computer-readable non-transitory storage media comprising instructions operable to, when executed by at least one processor, enable the at least one processor to cause a wireless communication device to perform any of the described operations of any of Examples 1-53.

Example 57 comprises an apparatus comprising: a memory interface; and processing circuitry configured to: perform any of the described operations of any of Examples 1-53.

Example 58 comprises a method comprising any of the described operations of any of Examples 1-53.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a first station (STA) to:
set up a Target Wake Time (TWT) agreement with a second STA, the TWT agreement to define a plurality of TWT Service Periods (SPs) for the first STA according to a first setting of one or more TWT SP parameters; and
select to transmit a frame to the second STA after setting up the TWT agreement, the frame comprising one or more TWT parameter fields configured to update a definition of one or more TWT SPs of the plurality of TWT SPs according to a second setting of the one or more TWT SP parameters, wherein the second setting of the one or more TWT SP parameters is different from the first setting of the one or more TWT SP parameters.

2. The apparatus of claim 1 configured to cause the first STA to select to transmit the frame after one or more first TWT SPs of the plurality of TWT SPs, the one or more first TWT SPs defined according to the first setting of the one or more TWT SP parameters, wherein the one or more TWT parameter fields in the frame are configured to update a definition of one or more second TWT SPs of the plurality of TWT SPs according to the second setting of the one or more TWT SP parameters.

3. The apparatus of claim 1, wherein the one or more TWT SP parameters comprise one or more TWT SP timing parameters.

4. The apparatus of claim 1, wherein the one or more TWT parameter fields comprise a target-wake-time field to indicate a start time of a next TWT SP after transmission of the frame.

5. The apparatus of claim 1, wherein the one or more TWT parameter fields comprise at least one field configured to indicate a time interval between two consecutive TWT SPs.

6. The apparatus of claim 1, wherein the one or more TWT parameter fields comprise a TWT wake interval mantissa field and a wake interval exponent field, which are configured to indicate a time interval between two consecutive TWT SPs.

7. The apparatus of claim 1, wherein the one or more TWT parameter fields comprise a duration field configured to indicate a TWT SP duration.

8. The apparatus of claim 1 configured to cause the first STA to:
transmit a first frame to the second STA to set up the TWT agreement, the first frame comprising a first setting of the one or more TWT parameter fields to define the plurality of TWT SPs according to the first setting of the one or more TWT SP parameters; and
transmit a second frame to the second STA, the second frame comprising a second setting of the one or more TWT parameter fields to update the definition of the one or more TWT SPs according to the second setting of the one or more TWT SP parameters.

9. The apparatus of claim 1, wherein the frame comprises a TWT information frame.

10. The apparatus of claim 9, wherein the TWT information frame comprises a new-TWT-parameters field comprising the one or more TWT parameter fields configured to update the definition of the one or more TWT SPs according to the second setting of the one or more TWT SP parameters.

11. The apparatus of claim 9, wherein the TWT information frame comprises a TWT information field comprising a next TWT subfield, wherein the next TWT subfield comprises the one or more TWT parameter fields configured to update the definition of the one or more TWT SPs according to the second setting of the one or more TWT SP parameters.

12. The apparatus of claim 1, wherein the frame comprises a TWT flow Identifier (ID) field comprising a TWT flow ID of the TWT agreement.

13. The apparatus of claim 1, wherein the TWT agreement comprises a Peer-to-Peer (P2P) TWT agreement, wherein the plurality of TWT SPs comprises a plurality of P2P TWT SPs based on communications between the first STA and a third STA.

14. The apparatus of claim 13 configured to cause the first STA to determine the second setting of the one or more TWT SP parameters based on a schedule of the communications between the first STA and the third STA.

15. The apparatus of claim 1, wherein the TWT agreement is configured to define the plurality of TWT SPs as TWT SPs during which the first STA is to be unavailable for communication with the second STA.

16. The apparatus of claim 1 configured to cause the first STA to transmit to the second STA a capability indication to indicate that the first STA supports a TWT parameter update mode.

17. The apparatus of claim 1 comprising at least one radio to transmit the frame.

18. The apparatus of claim 17 comprising one or more antennas connected to the radio, and a processor to execute instructions of an operating system.

19. A product comprising one or more tangible computer-readable non-transitory storage media comprising instructions operable to, when executed by at least one processor, enable the at least one processor to cause a first wireless communication station (STA) to:
set up a Target Wake Time (TWT) agreement with a second STA, the TWT agreement to define a plurality of TWT Service Periods (SPs) for the first STA according to a first setting of one or more TWT SP parameters; and
select to transmit a frame to the second STA after setting up the TWT agreement, the frame comprising one or more TWT parameter fields configured to update a definition of one or more TWT SPs of the plurality of TWT SPs according to a second setting of the one or more TWT SP parameters, wherein the second setting of the one or more TWT SP parameters is different from the first setting of the one or more TWT SP parameters.

20. The product of claim 19, wherein the instructions, when executed, cause the first STA to:
transmit a first frame to the second STA to set up the TWT agreement, the first frame comprising a first setting of the one or more TWT parameter fields to define the plurality of TWT SPs according to the first setting of the one or more TWT SP parameters; and
transmit a second frame to the second STA, the second frame comprising a second setting of the one or more TWT parameter fields to update the definition of the one or more TWT SPs according to the second setting of the one or more TWT SP parameters.
